(19) United States
(12) Patent Application Publication
(10) Pub. No.: US 2022/0163360 A1
(43) Pub. Date: May 26, 2022

(54) AIR FLOW RATE MEASUREMENT DEVICE

(71) Applicant: DENSO CORPORATION, Kariya-city (JP)

(72) Inventors: Akiyuki SUDOU, Kariya-city (JP); Yasushi GOKA, Kariya-city (JP)

(21) Appl. No.: 17/666,155

(22) Filed: Feb. 7, 2022

Related U.S. Application Data
(63) Continuation of application No. PCT/JP2020/033289, filed on Sep. 2, 2020.

(30) Foreign Application Priority Data
Sep. 4, 2019 (JP) 2019-161247

(51) Int. Cl. G01F 1/69; G01F 15/14

(52) U.S. Cl. CPC G01F 1/69; G01F 15/14

(57) ABSTRACT

A circuit board is located in a flow rate measurement passage of a housing. The flow rate measurement passage has: a first inner surface that is located at one side of the flow rate measurement passage where a primary lateral surface of the housing is placed; and a second inner surface that is located at another side of the flow rate measurement passage where a secondary lateral surface of the housing is placed. A flow rate sensing device is installed to one side of the circuit board where the first inner surface is placed. A distance, which is measured from the circuit board to the first inner surface in a plate thickness direction of the circuit board, is larger than a distance, which is measured from the circuit board to the second inner surface in the plate thickness direction of the circuit board.

### CROSS REFERENCE TO RELATED APPLICATIONS

This application is a continuation application of International Patent Application No. PCT/JP2020/033289 filed on Sep. 2, 2020, which designated the U.S. and claims the benefit of priority from Japanese Patent Application No. 2019-161247 filed on Sep. 4, 2019. The entire disclosures of all of the above applications are incorporated herein by reference.

### TECHNICAL FIELD

The present disclosure relates to an air flow rate measurement device.

### BACKGROUND

Previously, there has been proposed a sensor device that includes a flow rate sensor, which measures a flow rate of air, and a temperature sensor, which measures the temperature of the air. In the sensor device, the flow rate sensor and the temperature sensor are installed to a printed circuit board.

### SUMMARY

This section provides a general summary of the disclosure, and is not a comprehensive disclosure of its full scope or all of its features.

According to the present disclosure, there is provided an air flow rate measurement device that includes a housing, a circuit board and a flow rate sensing device. The circuit board is located in a flow rate measurement passage of the housing. The flow rate sensing device is configured to output a signal which corresponds to a flow rate of air flowing in the flow rate measurement passage. The flow rate measurement passage has a first inner surface and a second inner surface. The first inner surface is located at one side of the flow rate measurement passage where a primary lateral surface of the housing is placed. The second inner surface is located at another side of the flow rate measurement passage where a secondary lateral surface of the housing is placed. The flow rate sensing device is installed to one side of the circuit board where the first inner surface is placed. A distance, which is measured from the circuit board to the first inner surface in a plate thickness direction of the circuit board, is larger than a distance, which is measured from the circuit board to the second inner surface in the plate thickness direction of the circuit board.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic diagram of an engine system, in which an air flow rate measurement device of respective embodiments is used.

FIG. 2 is a front view of the air flow rate measurement device of a first embodiment.

FIG. 3 is a side view of the air flow rate measurement device.

FIG. 4 is another side view of the air flow rate measurement device.

FIG. 5 is a cross-sectional view taken along line V-V in FIG. 2.

FIG. 6 is an enlarged cross-sectional view taken along line VI-VI in FIG. 5.

FIG. 7 is an enlarged cross-sectional view taken along line VII-VII in FIG. 2.

FIG. 8 is an enlarged view of an area VIII in FIG. 6.

FIG. 9 is an enlarged view of an area IX in FIG. 7.

FIG. 10 is a cross-sectional view of a circuit board and a flow rate sensing device of the air flow rate measurement device.

FIG. 11 is a front view of an air flow rate measurement device of a second embodiment.

FIG. 12 is a side view of the air flow rate measurement device.

FIG. 13 is another side view of the air flow rate measurement device.

FIG. 14 is a cross-sectional view taken along line XIV-XIV in FIG. 11.

FIG. 15 is an enlarged cross-sectional view taken along line XV-XV in FIG. 14.

FIG. 16 is a cross-sectional view of a circuit board and a physical quantity sensing device of an air flow rate measurement device of another embodiment.

FIG. 17 is a cross-sectional view of a circuit board and a physical quantity sensing device of an air flow rate measurement device of another embodiment.

FIG. 18 is a cross-sectional view of a circuit board and a circuit board protector of an air flow rate measurement device of another embodiment.

FIG. 19 is a cross-sectional view of a circuit board and a circuit board protector of an air flow rate measurement device of another embodiment.

FIG. 20 is a cross-sectional view of an air flow rate measurement device of another embodiment.

FIG. 21 is a cross-sectional view of a circuit board and a physical quantity sensing device of an air flow rate measurement device of another embodiment.

### DETAILED DESCRIPTION

Previously, there has been proposed a sensor device that includes a flow rate sensor, which measures a flow rate of air, and a temperature sensor, which measures the temperature of the air. In the sensor device, the flow rate sensor and the temperature sensor are installed to a printed circuit board.

Since the printed circuit board is shaped in a form of a relatively thin plate, it is relatively difficult to process the printed circuit board into a shape that extends along the streamline of the air. Moreover, since the processing of the printed circuit board is relatively difficult, the dimensional accuracy of the printed circuit board is relatively low. According to the study of the inventors of the present application, due to the difficulty in the processing of the printed circuit board and the low dimensional accuracy of the printed circuit board, the structure of the above sensor device is likely to cause a disturbance of the flow of the air flowing around the printed circuit board and thereby result in the unstable flow of the air. Therefore, the measurement accuracy of the flow rate of the air by the flow rate sensor is deteriorated.

According to one aspect of the present disclosure, there is provided an air flow rate measurement device including:

a housing that has:
a base surface;
a back surface that is opposed to the base surface;
a primary lateral surface that is connected to one end part of the base surface and one end part of the back surface;
a secondary lateral surface that is connected to another end part of the base surface, which is opposite to the primary lateral surface, and another end part of the back surface, which is opposite to the primary lateral surface;
a flow rate measurement passage inlet that is formed at the base surface;
a flow rate measurement passage outlet that is formed at the back surface; and
a flow rate measurement passage that is communicated with the flow rate measurement passage inlet and the flow rate measurement passage outlet;

a circuit board that is located in the flow rate measurement passage; and

a flow rate sensing device that is configured to output a signal which corresponds to a flow rate of air flowing in the flow rate measurement passage, wherein:

the flow rate measurement passage has:
a first inner surface that is located at one side of the flow rate measurement passage where the primary lateral surface is placed; and
a second inner surface that is located at another side of the flow rate measurement passage where the secondary lateral surface is placed;

the flow rate sensing device is installed to one side of the circuit board where the first inner surface is placed; and

a distance, which is measured from the circuit board to the first inner surface in a plate thickness direction of the circuit board, is larger than a distance, which is measured from the circuit board to the second inner surface in the plate thickness direction of the circuit board.

With the above-described structure, the measurement accuracy of the flow rate of the air can be increased.

Hereinafter, embodiments will be described with reference to the drawings. In each of the following embodiments, the same or equivalent portions will be indicated by the same reference signs, and redundant description thereof will be omitted for the sake of simplicity.

### First Embodiment

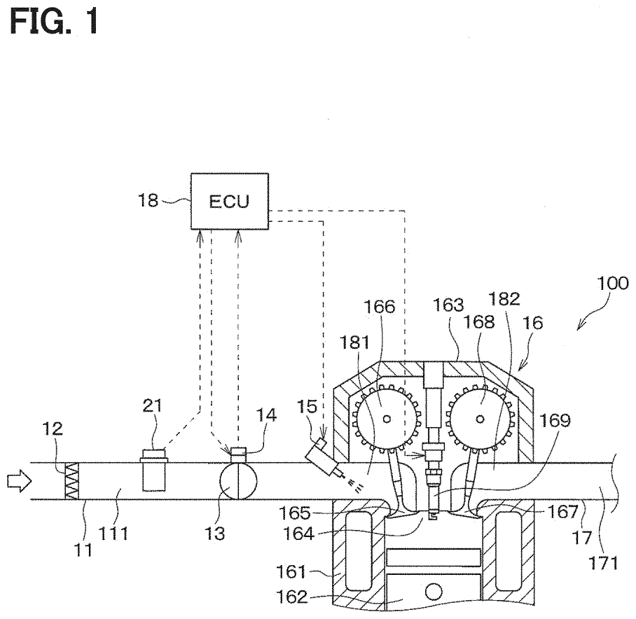

An air flow rate measurement device 21 is used, for example, in an air intake system of an engine system 100 installed to a vehicle. First of all, this engine system 100 will be described. Specifically, as shown in FIG. 1, the engine system 100 includes an air intake pipe 11, an air cleaner 12, an air flow rate measurement device 21, a throttle valve 13, a throttle sensor 14, injectors 15, an engine 16, an exhaust pipe 17 and an electronic control device 18. In this description, intake air refers to air that is drawn into the engine 16. Furthermore, exhaust gas refers to gas that is discharged from the engine 16.

The air intake pipe 11 is shaped into a cylindrical tubular form and has an air intake passage 111. The air intake passage 111 is configured to conduct the air to be drawn into the engine 16.

The air cleaner 12 is installed in the air intake pipe 11 at an upstream side section of the air intake passage 111, which is located on an upstream side in a flow direction of the air flowing in the air intake passage 111. Furthermore, the air cleaner 12 is configured to remove foreign objects, such as dust, contained in the air flowing in the air intake passage 111.

The air flow rate measurement device 21 is located on a downstream side of the air cleaner 12 in the flow direction of the air flowing in the air intake passage 111. The air flow rate measurement device 21 is configured to measure the flow rate of the air, which flows in the air intake passage 111, at a location between the air cleaner 12 and the throttle valve 13. In this embodiment, the air flow rate measurement device 21 is also configured to measure a physical quantity of the air that flows in the air intake passage 111. Details of the airflow rate measurement device 21 will be described later. In this embodiment, the physical quantity of the air, which flows in the air intake passage 111, is a physical quantity that is different from the flow rate of the air, which flows in the air intake passage 111, and this physical quantity is the temperature of the air as discussed later in detail.

The throttle valve 13 is located on a downstream side of the air flow rate measurement device 21 in the flow direction of the air flowing in the air intake passage 111. Furthermore, the throttle valve 13 is shaped into a circular disk form and is rotated by an electric motor (not shown). The throttle valve 13 is configured to adjust a size of a passage cross-sectional area of the air intake passage 111 and thereby adjust the flow rate of the air to be drawn into the engine 16 through rotation of the throttle valve 13.

The throttle sensor 14 is configured to output a measurement signal, which corresponds to an opening degree of the throttle valve 13, to the electronic control device 18.

The injector 15 is configured to inject the fuel into a combustion chamber 164 of the engine 16 based on a signal outputted from the electronic control device 18 described later.

The engine 16 is an internal combustion engine where a mixture gas, which is a mixture of the air flowing from the air intake passage 111 through the throttle valve 13 and the fuel injected from the injector 15, is combusted in the combustion chamber 164. An explosive force, which is generated by this combustion, causes a piston 162 of the engine 16 to reciprocate in a cylinder 161. Specifically, the engine 16 includes cylinders 161, pistons 162, a cylinder head 163, combustion chambers 164, intake valves 165, an intake valve drive device 166, exhaust valves 167, an exhaust valve drive device 168 and spark plugs 169.

The cylinder 161 is shaped in a tubular form and receives the piston 162. The piston 162 is configured to reciprocate in the cylinder 161 in an axial direction of the cylinder 161. The cylinder head 163 is installed at upper portions of the cylinders 161. Furthermore, the cylinder head 163 is connected to the air intake pipe 11 and the exhaust pipe 17 and has a first cylinder passage 181 and a second cylinder passage 182. The first cylinder passage 181 is communicated with the air intake passage 111. The second cylinder passage 182 is communicated with an exhaust passage 171 of the exhaust pipe 17 described later. The combustion chamber 164 is defined by the cylinder 161, a top surface of the piston 162 and a lower surface of the cylinder head 163. The intake valve 165 is placed in the first cylinder passage 181 and is configured to be driven by the intake valve drive device 166 to open and close the combustion chamber 164 at the first cylinder passage 181 side. The exhaust valve 167 is placed in the second cylinder passage 182 and is configured to be driven by the exhaust valve drive device 168 to open and close the combustion chamber 164 at the second cylinder passage 182 side.

The spark plug 169 is configured to ignite the mixture gas of the combustion chamber 164, which is the mixture of the air flowing from the air intake passage 111 through the throttle valve 13 and the fuel injected from the injector 15, based on the signal outputted from the electronic control device 18.

The exhaust pipe 17 is shaped in a cylindrical tubular form and has the exhaust passage 171. The exhaust passage 171 conducts the gas which is combusted in the combustion chambers 164. The gas, which flows in the exhaust passage 171, is purified by an exhaust gas purification device (not shown).

The electronic control device 18 includes a microcomputer as its main component and thereby has a CPU, a ROM, a RAM, an I/O device and a bus line for connecting these devices. Here, for example, the electronic control device 18 controls the opening degree of the throttle valve 13 based on, for example, the flow rate of the air and the physical quantity of the air measured with the air flow rate measurement device 21 and the current opening degree of the throttle valve 13. Furthermore, the electronic control device 18 controls a fuel injection amount of the respective injectors 15 and ignition timing of the respective spark plugs 169 based on, for example, the flow rate of the air and the physical quantity of the air measured with the air flow rate measurement device 21 and the current opening degree of the throttle valve 13. In FIG. 1, the electronic control device 18 is indicated as an ECU.

The engine system 100 has the above-described structure. Next, the air flow rate measurement device 21 will be described in detail.

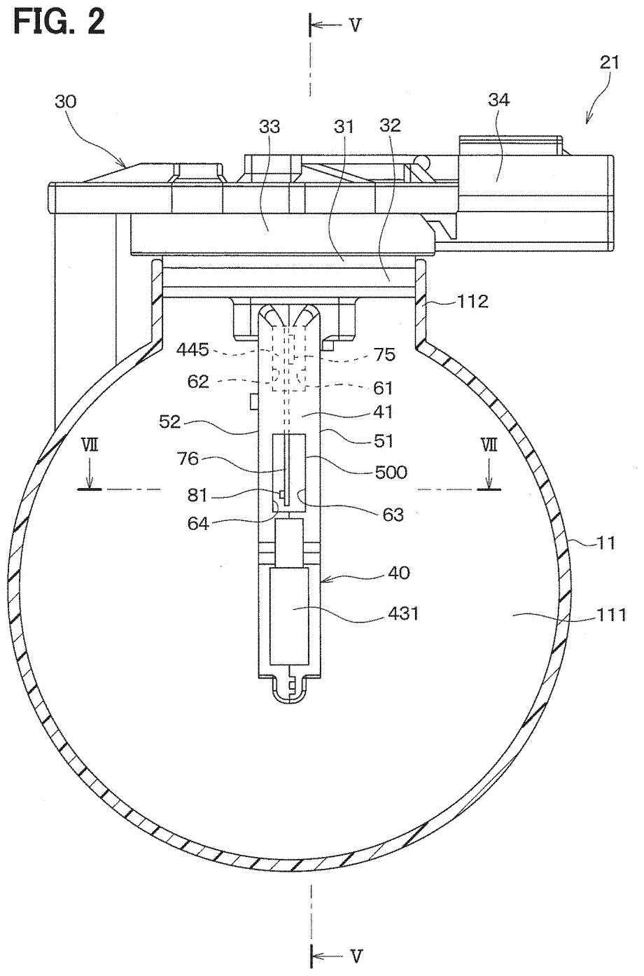

As shown in FIGS. 2 to 9, the air flow rate measurement device 21 includes a housing 30, a circuit board 76, a plurality of primary circuit board protectors 771, a secondary circuit board protector 772, a flow rate sensing device 75 and a physical quantity sensing device 81.

As shown in FIG. 2, the housing 30 is installed to a pipe extension 112 that is connected to a peripheral wall of the air intake pipe 11. The pipe extension 112 is shaped in a cylindrical tubular form and extends from the peripheral wall of the air intake pipe 11 in a radial direction of the air intake pipe 11 from a radially inner side toward a radially outer side. Furthermore, the housing 30 includes a holding portion 31, a seal member 32, a lid 33, a connector cover 34, terminals 35 and a bypass portion 40.

The holding portion 31 is shaped in a cylindrical tubular form and is fixed to the pipe extension 112 when an outer surface of the holding portion 31 is fitted to an inner surface of the pipe extension 112. Furthermore, a groove, into which the seal member 32 is fitted, is formed at an outer peripheral surface of the holding portion 31.

The seal member 32 is for example, an O-ring and is installed in the groove of the holding portion 31. The seal member 32 closes a passage in the pipe extension 112 when the seal member 32 contacts the pipe extension 112. Thereby, leakage of the air, which flows in the air intake passage 111, to the outside through the pipe extension 112 is limited.

The lid 33 is shaped in a bottomed tubular form and is connected to the holding portion 31 in an axial direction of the holding portion 31. Furthermore, a length of the lid 33, which is measured in a radial direction of the holding portion 31, is larger than a diameter of the pipe extension 112, and the lid 33 closes a hole of the pipe extension 112.

The connector cover 34 is connected to the lid 33 and extends from a radially inner side toward a radially outer side in the radial direction of the holding portion 31. Furthermore, the connector cover 34 is shaped in a tubular form and receives one end parts of the terminals 35.

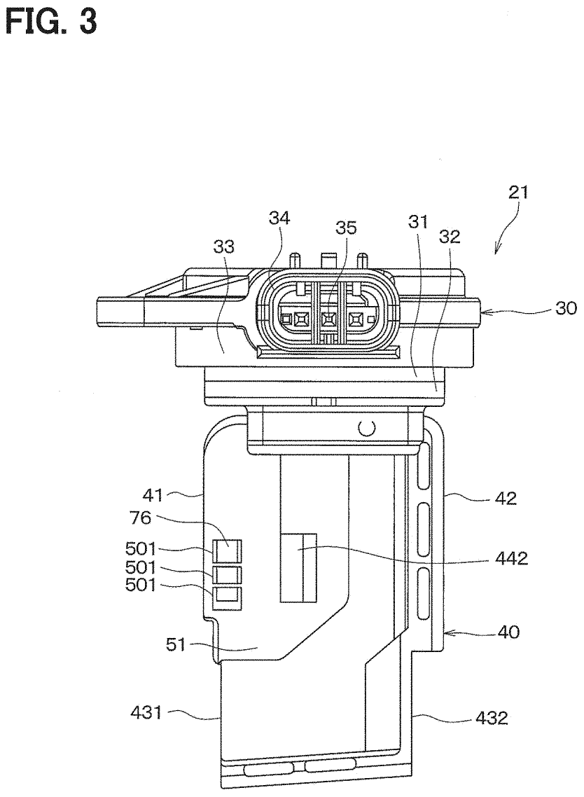

As shown in FIG. 3, the one end parts of the terminals 35 are received in the connector cover 34. Furthermore, although not depicted in the drawing, the one end parts of the terminals 35 are connected to the electronic control device 18. Also, center parts of the terminals 35 are received in the lid 33 and the holding portion 31. The other end parts of corresponding ones of the terminals 35 are connected to the circuit board 76 described later.

The bypass portion 40 includes a plurality of passages and is shaped in a planar form. Specifically, as shown in FIGS. 2 to 7, the bypass portion 40 includes a housing base surface 41, a housing back surface 42, a primary housing lateral surface 51 and a secondary housing lateral surface 52. Furthermore, the bypass portion 40 includes a flow rate measurement main passage inlet (flow rate measurement passage inlet) 431, a flow rate measurement main passage outlet (flow rate measurement passage outlet) 432, a flow rate measurement main passage (flow rate measurement passage) 43, a flow rate measurement sub-passage inlet 441, a flow rate measurement sub-passage (flow rate measurement passage) 44 and a plurality of flow rate measurement sub-passage outlet 442. Furthermore, the bypass portion 40 includes a physical quantity measurement passage inlet 500, a physical quantity measurement passage 50, a plurality of primary physical quantity measurement passage outlets (a plurality of physical quantity measurement passage outlets) 501 and a plurality of secondary physical quantity measurement passage outlets (a plurality of physical quantity measurement passage outlets) 502. In the following description, a side of the bypass portion 40, at which the holding portion 31 of the housing 30 is placed, will be referred to as an upper side. Furthermore, another side of the bypass portion 40, which is opposite to the holding portion 31, will be referred to as a lower side.

The housing base surface 41 is located on an upstream side in the flow direction of the air flowing in the air intake passage 111. The housing back surface 42 is located on a side that is opposite to the housing base surface 41. The primary housing lateral surface 51 serves as a primary lateral surface and is joined to one end part of the housing base surface 41 and one end part of the housing back surface 42. The secondary housing lateral surface 52 serves as a secondary lateral surface and is joined to another end part of the housing base surface 41 and another end part of the housing back surface 42, which are opposite to the primary housing lateral surface 51. Furthermore, the housing base surface 41, the housing back surface 42, the primary housing lateral surface 51 and the secondary housing lateral surface 52 are respectively shaped in a stepped form.

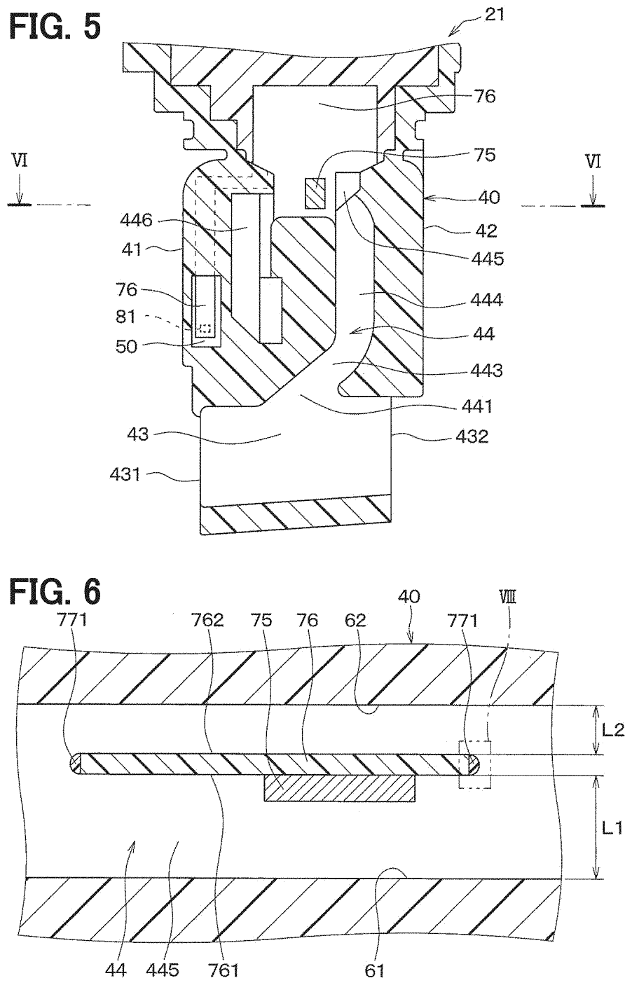

As shown in FIGS. 2 to 5, the flow rate measurement main passage inlet 431 is formed at the housing base surface 41 and introduces a portion of the air, which flows in the air intake passage 111, into the flow rate measurement main passage 43. As shown in FIG. 5, the flow rate measurement main passage 43 is communicated with the flow rate measurement main passage inlet 431 and the flow rate measurement main passage outlet 432. As shown in FIGS. 3 to 5, the flow rate measurement main passage outlet 432 is formed at the housing back surface 42.

As shown in FIG. 5, the flow rate measurement sub-passage inlet 441 is formed at the upper side of the flow rate measurement main passage 43 and introduces a portion of the air, which flows in the flow rate measurement main passage 43, into the flow rate measurement sub-passage 44. The flow rate measurement sub-passage 44 is a passage that is branched from the middle of the flow rate measurement main passage 43. The flow rate measurement sub-passage 44 includes an introducing portion 443, a rear vertical portion 444, a return portion 445 and a front vertical portion 446. The introducing portion 443 is connected to the flow rate measurement sub-passage inlet 441 and extends from the flow rate measurement sub-passage inlet 441 in an upward direction and also in a direction that is directed from the flow rate measurement sub-passage inlet 441 toward the housing back surface 42. Thereby, a portion of the air, which flows in the flow rate measurement main passage 43, can be easily introduced into the flow rate measurement sub-passage 44. The rear vertical portion 444 is connected to an end part of the introducing portion 443, which is opposite to the flow rate measurement sub-passage inlet 441, and the rear vertical portion 444 extends from this end part of the introducing portion 443 in the upward direction. The return portion 445 is connected to an end part of the rear vertical portion 444, which is opposite to the introducing portion 443, and the return portion 445 extends from this end part of the rear vertical portion 444 toward the housing base surface 41. The front vertical portion 446 is connected to an end part of the return portion 445, which is opposite to the rear vertical portion 444, and the front vertical portion 446 extends from this end part of the return portion 445 in the downward direction. In a cross-sectional view shown in FIG. 5, in order to clearly indicate the respective passages, an outline of the flow rate measurement sub-passage inlet 441 and an outline of the secondary physical quantity measurement passage outlet 502 described later are omitted.

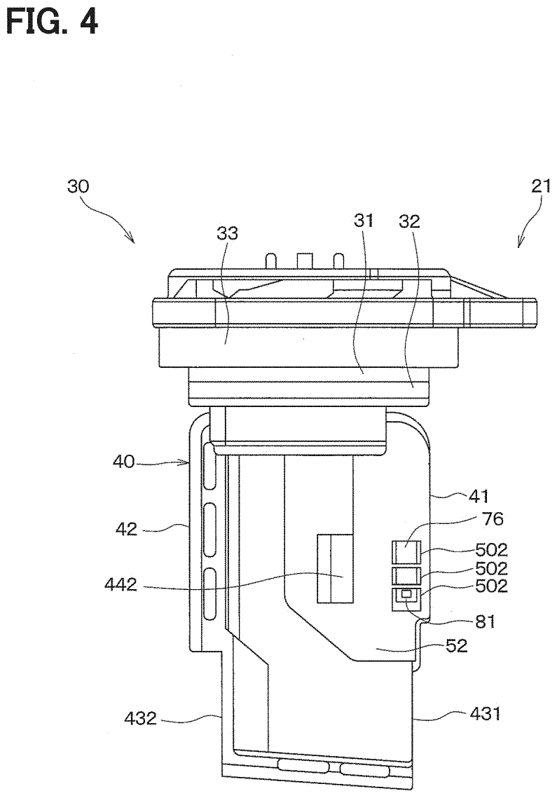

As shown in FIGS. 3 and 4, the flow rate measurement sub-passage outlets 442 are respectively formed at the primary housing lateral surface 51 and the secondary housing lateral surface 52 and are communicated with the front vertical portion 446 and the outside of the housing 30.

Furthermore, as shown in FIGS. 2 and 6, the return portion 445 of the flow rate measurement sub-passage 44 has a first housing inner surface 61 and a second housing inner surface 62. The first housing inner surface 61 corresponds to a first inner surface, and the first housing inner surface 61 is an inner surface of the return portion 445 of the flow rate measurement sub-passage 44 located on a side where the primary housing lateral surface 51 is placed. The second housing inner surface 62 corresponds to a second inner surface, and the second housing inner surface 62 is an inner surface of the return portion 445 of the flow rate measurement sub-passage 44 located on another side where the secondary housing lateral surface 52 is placed.

As shown in FIG. 2, the physical quantity measurement passage inlet 500 is formed at the housing base surface 41 at a location, which is on the upper side of the flow rate measurement main passage inlet 431. The physical quantity measurement passage inlet 500 introduces a portion of the air, which flows in the air intake passage 111, into the physical quantity measurement passage 50.

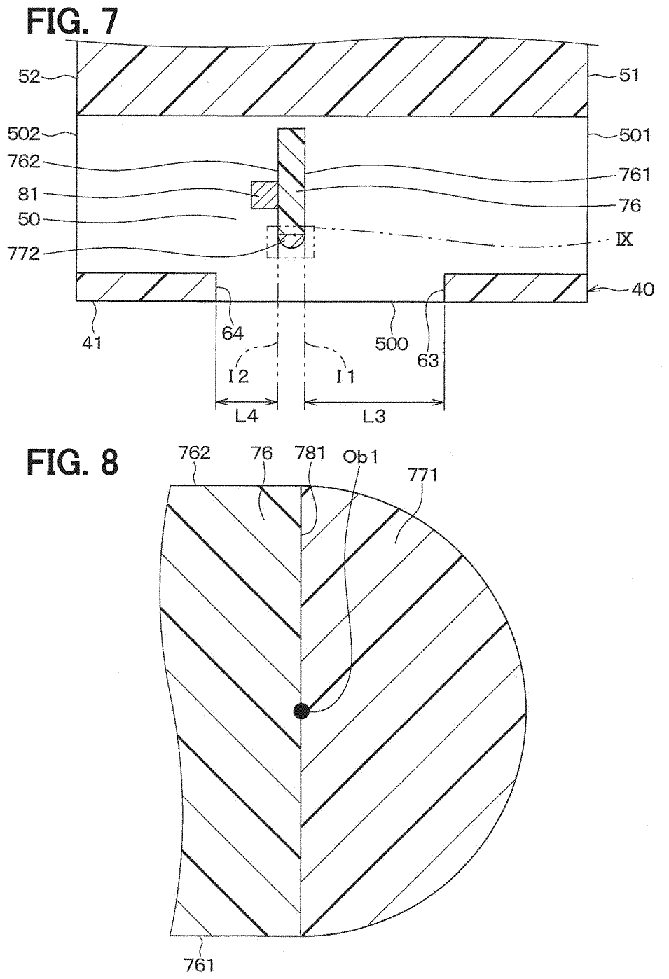

As shown in FIGS. 5 and 7, the physical quantity measurement passage 50 is communicated with the physical quantity measurement passage inlet 500 and is also communicated with the primary physical quantity measurement passage outlet 501 and the secondary physical quantity measurement passage outlet 502.

As shown in FIGS. 3 and 7, the primary physical quantity measurement passage outlets 501 are formed at the primary housing lateral surface 51.

As shown in FIGS. 4 and 7, the secondary physical quantity measurement passage outlets 502 are formed at the secondary housing lateral surface 52.

Furthermore, as shown in FIG. 7, the physical quantity measurement passage inlet 500 has a third housing inner surface 63 and a fourth housing inner surface 64. The third housing inner surface 63 is located at a side of the physical quantity measurement passage inlet 500 where the primary housing lateral surface 51 is placed, and the third housing inner surface 63 is connected to the housing base surface 41. The fourth housing inner surface 64 serves as a third inner surface and is located at another side of the physical quantity measurement passage inlet 500 where the secondary housing lateral surface 52 is placed, and the fourth housing inner surface 64 is connected to the housing base surface 41.

The circuit board 76 is, for example, a printed circuit board and is electrically connected to the other end parts of the corresponding terminals 35. Furthermore, as shown in FIG. 6, a corresponding section of the circuit board 76 is located in the return portion 445 of the flow rate measurement sub-passage 44 and is opposed to the first housing inner surface 61 and the second housing inner surface 62. Here, an end part of the circuit board 76, which is located on the side where the first housing inner surface 61 is placed, will be referred to as a primary circuit board end part 761. Also, an end part of the circuit board 76, which is located on the other side where the second housing inner surface 62 is placed, will be referred to as a secondary circuit board end part 762.

Furthermore, as shown in FIG. 5, the circuit board 76 extends from the location of the return portion 445 of the flow rate measurement sub-passage 44 to the location of the physical quantity measurement passage 50. As shown in FIG. 7, a corresponding section of the circuit board 76 is located in the physical quantity measurement passage 50. Furthermore, as shown in FIGS. 3 and 7, the primary circuit board end part 761 is opposed to the primary physical quantity measurement passage outlets 501. Furthermore, as shown in FIGS. 4 and 7, the secondary circuit board end part 762 is opposed to the secondary physical quantity measurement passage outlets 502.

As shown in FIG. 6, each of the primary circuit board protectors 771 is formed by, for example, coating resin to a corresponding surface of the circuit board 76, which is located in the return portion 445 of the flow rate measurement sub-passage 44 and extends in a plate thickness direction of the circuit board 76. In this instance, the primary circuit board protectors 771 are formed at two opposed surfaces of the circuit board 76 which are located on an upstream side and a downstream side, respectively, of the circuit board 76 in the flow direction of the air which flows in the return portion 445 of the flow rate measurement sub-passage 44. The primary circuit board protectors 771 cover the two opposed surfaces of the circuit board 76, which extend in the plate thickness direction of the circuit board 76, to protect the circuit board 76. Furthermore, as shown in FIG. 8, in a cross-section of the primary circuit board protector 771 which is perpendicular to a longitudinal direction of the circuit board 76, an outer periphery of each of the primary circuit board protectors 771 is curved. Furthermore, in the cross section, which is perpendicular to the longitudinal direction of the circuit board 76, a primary center of curvature Ob1 of the outer periphery of the primary circuit board protector 771 is located at an inside of one of the circuit board 76 and the primary circuit board protector 771, and the outer periphery of the primary circuit board protector 771 is convexly curved. In this instance, the outer periphery of the primary circuit board protector 771 has a semi-circular shape, and the primary center of curvature Ob1 is located at a primary boundary surface 781 that is a boundary between the circuit board 76 and the primary circuit board protector 771.

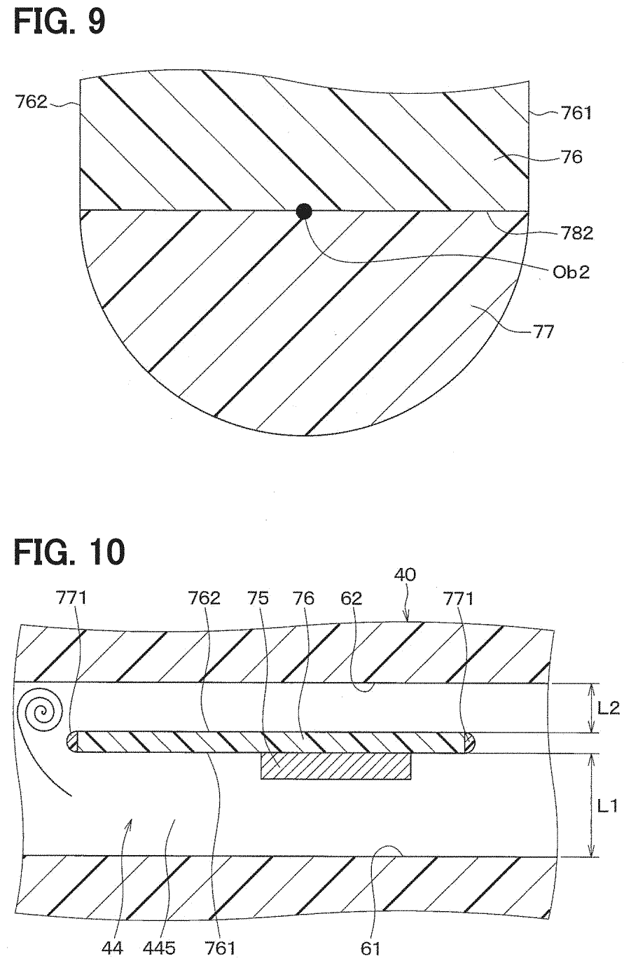

As shown in FIG. 7, the secondary circuit board protector 772 is formed by, for example, coating resin to a corresponding surface of the circuit board 76, which is located in the physical quantity measurement passage 50 and extends in the plate thickness direction of the circuit board 76. The secondary circuit board protector 772 is opposed to the physical quantity measurement passage inlet 500 and covers the surface of the circuit board 76, which extends in the plate thickness direction of the circuit board 76, to protect the circuit board 76. Furthermore, as shown in FIG. 9, in the cross-section which is perpendicular to the longitudinal direction of the circuit board 76, an outer periphery of the secondary circuit board protectors 772 is curved. Furthermore, in the cross section, which is perpendicular to the longitudinal direction of the circuit board 76, a secondary center of curvature Ob2 of the outer periphery of the secondary circuit board protector 772 is located at an inside of one of the circuit board 76 and the secondary circuit board protector 772, and the outer periphery of the secondary circuit board protector 772 is convexly curved. In this instance, the outer periphery of the secondary circuit board protector 772 has a semi-circular shape, and the secondary center of curvature Ob2 is located at a secondary boundary surface 782 that is a boundary between the circuit board 76 and the secondary circuit board protector 772.

As shown in FIGS. 5 and 6, the flow rate sensing device 75 is installed to the corresponding section of the circuit board 76 located in the return portion 445 of the flow rate measurement sub-passage 44. Furthermore, the flow rate sensing device 75 is installed to the primary circuit board end part 761 of the circuit board 76 and is opposed to the first housing inner surface 61. The flow rate sensing device 75 outputs a signal which corresponds to a flow rate of the air flowing in the flow rate measurement sub-passage 44. Specifically, the flow rate sensing device 75 includes a semiconductor that has a heating element and a thermosensitive element. This semiconductor contacts the air flowing in the flow rate measurement sub-passage 44, and thereby heat transfer occurs between the semiconductor and the air flowing in the flow rate measurement sub-passage 44. Due to this heat transfer, the temperature of the semiconductor changes. This temperature change correlates to the flow rate of the air flowing in the flow rate measurement sub-passage 44. Therefore, at the flow rate sensing device 75, a signal, which corresponds to this temperature change, is outputted, and thereby the flow rate sensing device 75 outputs a signal that corresponds to the flow rate of the air flowing in the flow rate measurement sub-passage 44. The output signal of the flow rate sensing device 75 is transmitted to the electronic control device 18 through the circuit board 76 and the corresponding terminal 35.

Here, as shown in FIG. 6, in the cross section, which is perpendicular to the longitudinal direction of the circuit board 76, a distance, which is measured from the first housing inner surface 61 to the primary circuit board end part 761 in the plate thickness direction of the circuit board 76, is defined as a first distance L1. Also, in the cross section, which is perpendicular to the longitudinal direction of the circuit board 76, a distance, which is measured from the second housing inner surface 62 to the secondary circuit board end part 762 in the plate thickness direction of the circuit board 76, is defined as a second distance L2. The first distance L1 is larger than the second distance L2. Furthermore, the second distance L2 is larger than zero, and the secondary circuit board end part 762 is not in contact with the second housing inner surface 62.

As shown in FIGS. 2, 4, 5 and 7, the physical quantity sensing device 81 is installed to the secondary circuit board end part 762 of the circuit board 76 and is located in the physical quantity measurement passage 50. Furthermore, as shown in FIGS. 2 and 7, the physical quantity sensing device 81 is opposed to the physical quantity measurement passage inlet 500. Also, as shown in FIGS. 4 and 7, the physical quantity sensing device 81 is opposed to one of the secondary physical quantity measurement passage outlets 502.

Here, as shown in FIG. 7, in the cross section, which is perpendicular to the longitudinal direction of the circuit board 76, a distance, which is measured from the third housing inner surface 63 to a first imaginary line 11 in the plate thickness direction of the circuit board 76, is defined as a third distance L3. The first imaginary line 11 is an imaginary line that extends along the primary circuit board end part 761 in a width direction of the circuit board 76. Also, in the cross section, which is perpendicular to the longitudinal direction of the circuit board 76, the third distance L3 corresponds to a distance, which is measured from the third housing inner surface 63 to the primary circuit board end part 761 in the plate thickness direction of the circuit board 76. Furthermore, in the cross section, which is perpendicular to the longitudinal direction of the circuit board 76, a distance, which is measured from the fourth housing inner surface 64 to a second imaginary line 12 in the plate thickness direction of the circuit board 76, is defined as a fourth distance L4. Here, the second imaginary line 12 is an imaginary line that extends along the secondary circuit board end part 762 in the width direction of the circuit board 76. Also, in the cross section, which is perpendicular to the longitudinal direction of the circuit board 76, the fourth distance L4 corresponds to a distance, which is measured from the fourth housing inner surface 64 to the secondary circuit board end part 762 in the plate thickness direction of the circuit board 76. The third distance L3 is larger than the fourth distance L4. Furthermore, the fourth distance L4 is larger than zero, and the physical quantity sensing device 81 is less likely to come into contact with the fourth housing inner surface 64.

The physical quantity sensing device 81 outputs a signal that corresponds to the physical quantity of the air, which flows in the physical quantity measurement passage 50. Here, the physical quantity of the air, which flows in the physical quantity measurement passage 50, is the temperature of the air, which flows in the physical quantity measurement passage 50. The physical quantity sensing device 81 includes, for example, a thermistor (not shown) and outputs the signal that corresponds to the temperature of the air, which flows in the physical quantity measurement passage 50. Furthermore, since the physical quantity sensing device 81 is installed to the circuit board 76, the output signal of the physical quantity sensing device 81 is transmitted to the electronic control device 18 through the circuit board 76 and the corresponding terminal 35.

The air flow rate measurement device 21 is constructed in the above-described manner. Next, the measurement of the flow rate and the temperature by the air flow rate measurement device 21 will be described.

A portion of the air, which flows in the air intake passage 111, flows into the flow rate measurement main passage inlet 431. The air, which flows from the flow rate measurement main passage inlet 431, flows in the flow rate measurement main passage 43 toward the flow rate measurement main passage outlet 432. A portion of the air, which flows in the flow rate measurement main passage 43, is discharged to the outside of the housing 30 through the flow rate measurement main passage outlet 432.

Furthermore, another portion of the air, which flows in the flow rate measurement main passage 43, flows into the flow rate measurement sub-passage inlet 441. The air, which flows from the flow rate measurement sub-passage inlet 441, flows in the return portion 445 after passing through the introducing portion 443 and the rear vertical portion 444 of the flow rate measurement sub-passage 44. A portion of the air, which flows in the return portion 445, contacts the flow rate sensing device 75. Due to the contact of the flow rate sensing device 75 with the air, the flow rate sensing device 75 outputs a signal that corresponds to the flow rate of the air, which flows in the flow rate measurement sub-passage 44. The output signal of the flow rate sensing device 75 is transmitted to the electronic control device 18 through the circuit board 76 and the corresponding terminal 35. Furthermore, a portion of the air, which flows in the return portion 445, is discharged to the outside of the housing 30 through the front vertical portion 446 and the flow rate measurement sub-passage outlets 442 of the flow rate measurement sub-passage 44.

Furthermore, a portion of the air, which flows in the air intake passage 111, flows into the physical quantity measurement passage inlet 500. The air, which flows from the physical quantity measurement passage inlet 500, flows in the physical quantity measurement passage 50. A portion of the air, which flows in the physical quantity measurement passage 50, contacts the physical quantity sensing device 81. Due to the contact of the physical quantity sensing device 81 with the air, the physical quantity sensing device 81 outputs the signal that corresponds to the temperature of the air flowing in the physical quantity measurement passage 50. The output signal of the physical quantity sensing device 81 is transmitted to the electronic control device 18 through the circuit board 76 and the corresponding terminal 35. Furthermore, the air, which flows in the physical quantity measurement passage 50, is discharged to the outside of the housing 30 through the primary physical quantity measurement passage outlets 501 and the secondary physical quantity measurement passage outlets 502.

As discussed above, the air flow rate measurement device 21 measures the flow rate of the air and the temperature of the air. The air flow rate measurement device 21 achieves the improved measurement accuracy of the flow rate of the air. In the following description, the improvement of the measurement accuracy will be described.

In the air flow rate measurement device 21, the flow rate sensing device 75 is installed to the primary circuit board end part 761 and is opposed to the first housing inner surface 61. Furthermore, the first distance L1 is larger than the second distance L2. Since the first distance L1 is larger than the second distance L2, a size of the passage cross-sectional area for the air flowing between the first housing inner surface 61 and the primary circuit board end part 761 is larger than a size of the passage cross-sectional area for the air between the second housing inner surface 62 and the secondary circuit board end part 762. Thus, the flow rate of the air flowing between the first housing inner surface 61 and the primary circuit board end part 761 is larger than the flow rate of the air flowing between the second housing inner surface 62 and the secondary circuit board end part 762. As a result, stagnation is more likely to occur at a location that is on the downstream side of the circuit board 76 in the return portion 445 of the flow rate measurement sub-passage 44 in the flow direction of the air and is on the second housing inner surface 62 side. Thus, as shown in FIG. 10, a vortex is likely to be generated at this position. Since this vortex is generated at the location that is on the downstream side of the circuit board 76 in the return portion 445 of the flow rate measurement sub-passage 44 in the flow direction of the air and is on the second housing inner surface 62 side, the vortex has no substantial influence on the air flowing between the first housing inner surface 61 and the primary circuit board end part 761. Furthermore, the generation of this vortex limits generation of other vortices, so that the air, which flows between the first housing inner surface 61 and the primary circuit board end part 761 is less affected by the vortex. Therefore, the air, which flows between the first housing inner surface 61 and the primary circuit board end part 761, is less likely to be turbulent and becomes a stable flow. Thus, the measurement accuracy of the flow rate of the air is improved at the air flow rate measurement device 21.

The air flow rate measurement device 21 can achieve the following advantages (1) to (7).

(1) The second distance L2 is larger than zero, and the secondary circuit board end part 762 is not in contact with the second housing inner surface 62. Thus, the heat is no longer conducted from the second housing inner surface 62 to the secondary circuit board end part 762, and thereby the amount of heat conducted from the housing 30 to the circuit board 76 is reduced. Since the amount of heat conducted from the secondary circuit board end part 762 to the primary circuit board end part 761 becomes relatively small, the amount of heat, which is conducted from the circuit board 76 to the flow rate sensing device 75, becomes relatively small. As a result, the flow rate sensing device 75 is less susceptible to the heat from the circuit board 76, and thereby the measurement accuracy of the flow rate of the air is improved.

(2) The physical quantity sensing device 81 is installed to the circuit board 76. Therefore, the air flow rate measurement device 21 can measure the physical quantity of the air that is different from the flow rate of the air. Furthermore, the flow rate sensing device 75 and the physical quantity sensing device 81 are installed to the common circuit board 76, so that the design of the respective parts becomes relatively easy. Thus, the manufacturing of the air flow rate measurement device 21 becomes relatively easy, and thereby the cost of the air flow rate measurement device 21 can be reduced.

(3) The physical quantity sensing device 81 is installed to the corresponding section of the circuit board 76 located in the physical quantity measurement passage 50 and measures the temperature of the air flowing in the physical quantity measurement passage 50. Since the physical quantity sensing device 81 is located in the physical quantity measurement passage 50 that is different from the flow rate measurement sub-passage 44, the physical quantity sensing device 81 does not disturb the air flowing in the return portion 445 of the flow rate measurement sub-passage 44. Therefore, the air, which flows between the first housing inner surface 61 and the primary circuit board end part 761, is less likely to be turbulent and becomes a stable flow. The measurement accuracy of the flow rate of the air is improved at the air flow rate measurement device 21.

(4) The physical quantity sensing device 81 is installed to the secondary circuit board end part 762 of the circuit board 76. Specifically, the physical quantity sensing device 81 is installed to the side of the circuit board 76 where the fourth housing inner surface 64 is placed. Furthermore, the fourth distance L4 is larger than zero, and the physical quantity sensing device 81 is less likely to come into contact with the fourth housing inner surface 64. Thus, heat conduction from the fourth housing inner surface 64 to the physical quantity sensing device 81 is less likely to occur, so that the amount of heat conducted from the housing 30 to the physical quantity sensing device 81 is reduced. As a result, the physical quantity sensing device 81 is less susceptible to the heat from the housing 30, and thereby the measurement accuracy of the temperature of the air is improved.

(5) In the air intake passage 111, a corrosive substance, such as salt water, may possibly flow along with the air. Therefore, in the air flow rate measurement device 21, into which the air flowing in the air intake passage 111 is introduced, each of the primary circuit board protectors 771 covers the corresponding surface of the circuit board 76, which extends in the plate thickness direction of the circuit board 76 and is located in the return portion 445 of the flow rate measurement sub-passage 44, so that the primary circuit board protector 771 protects the circuit board 76. Furthermore, the secondary circuit board protector 772 covers the corresponding surface of the circuit board 76, which extends in the plate thickness direction of the circuit board 76 and is located in the physical quantity measurement passage 50, so that the secondary circuit board protector 772 protects the circuit board 76. In this way, the corrosion of the circuit board 76 is limited.

(6) In the cross section, which is perpendicular to the longitudinal direction of the circuit board 76, the primary center of curvature Ob1 of the outer periphery of the primary circuit board protector 771 is located at the inside of the circuit board 76 and the primary circuit board protector 771, and the outer periphery of the primary circuit board protector 771 is convexly curved. Since the outer periphery of the primary circuit board protector 771 is convexly curved, the air, which flows in the return portion 445 of the flow rate measurement sub-passage 44, flows along the outer periphery of the primary circuit board protector 771. Thereby, the pressure loss of the air, which flows in the return portion 445 of the flow rate measurement sub-passage 44, is reduced, and a reduction in the flow rate of the air, which flows in the return portion 445 of the flow rate measurement sub-passage 44, is limited. Thus, the flow rate of the air, which flows in the return portion 445 of the flow rate measurement sub-passage 44, becomes relatively large, and thereby the flow rate sensing device 75 can be easily cooled. As a result, the flow rate sensing device 75 is less likely to be influenced by the heat transfer from the housing 30, and thereby the measurement accuracy of the flow rate of the air is improved.

(7) In the cross section, which is perpendicular to the longitudinal direction of the circuit board 76, the secondary center of curvature Ob2 of the outer periphery of the secondary circuit board protector 772 is located at the inside of the circuit board 76 and the secondary circuit board protector 772, and the outer periphery of the secondary circuit board protector 772 is convexly curved. Since the outer periphery of the secondary circuit board protector 772 is convexly curved, the air, which flows in the physical quantity measurement passage 50, flows along the outer periphery of the secondary circuit board protector 772. Thus, a pressure loss of the air, which flows in the physical quantity measurement passage 50, is reduced, and a decrease in the flow rate of the air, which flows in the physical quantity measurement passage 50, is limited. Therefore, the flow rate of the air, which flows in the physical quantity measurement passage 50, becomes relatively large, and thereby the physical quantity sensing device 81 can be easily cooled. Thus, the physical quantity sensing device 81 is less likely to be influenced by the heat transfer from the housing 30, and thereby the air flow rate measurement device 21 can improve the measurement accuracy of the temperature of the air.

### Second Embodiment

A second embodiment is different from the first embodiment with respect to the following points. In the second embodiment, the housing does not have the physical quantity measurement passage inlet, the primary physical quantity measurement passage outlets, the secondary physical quantity measurement passage outlets and the physical quantity measurement passage. Furthermore, in the second embodiment, the locations of the circuit board and the physical quantity sensing device are different from those of the first embodiment. Furthermore, in the second embodiment, the location and the configuration of each of the secondary circuit board protectors are different from those of the first embodiment. Here, for the sake of convenience, the physical quantity sensing device of the second embodiment will be referred to as the physical quantity sensing device.

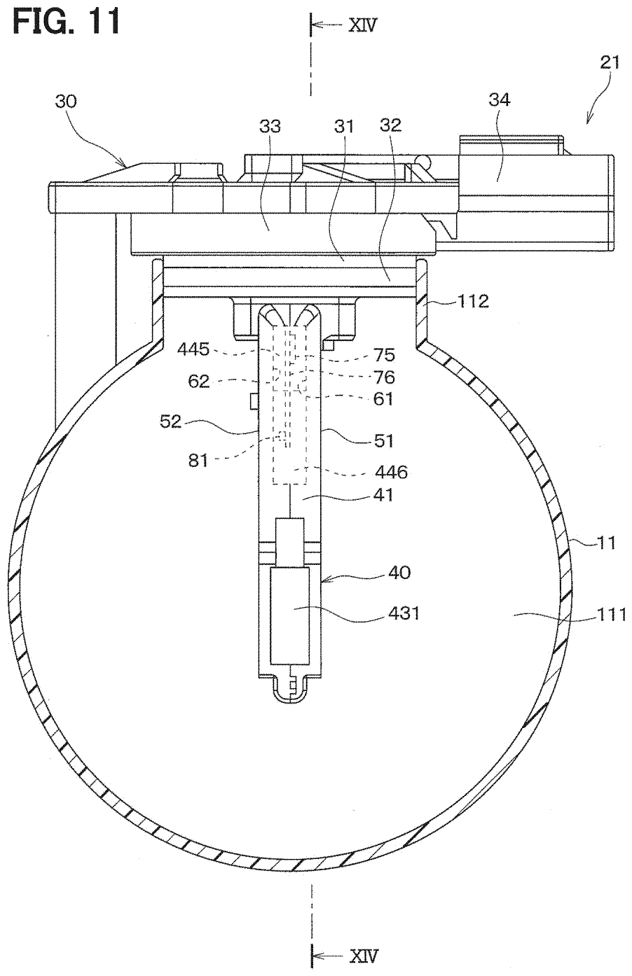

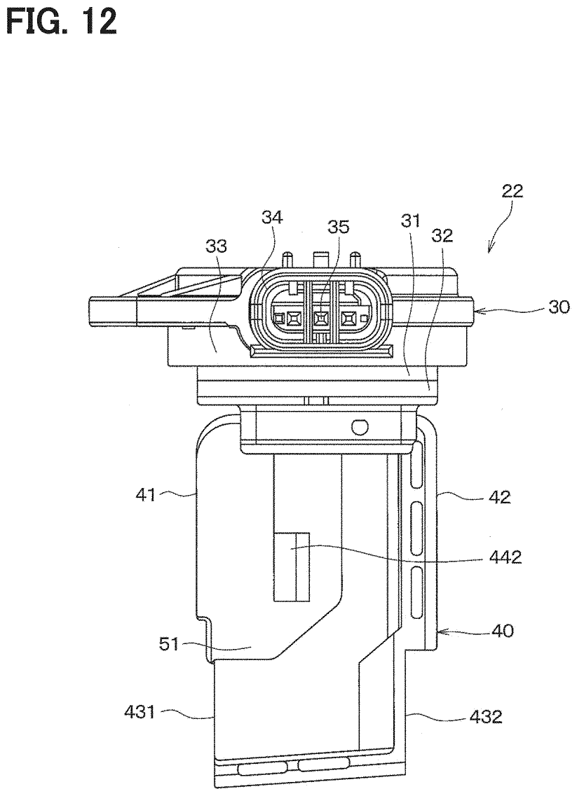

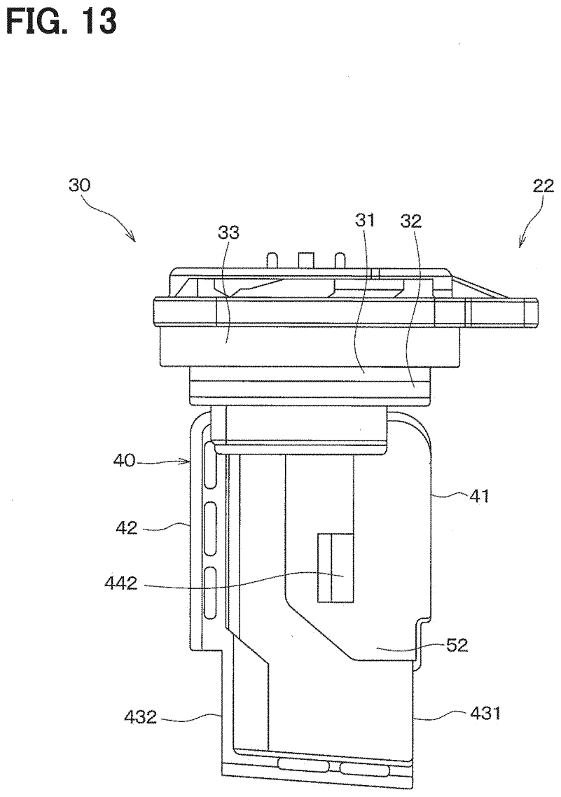

As shown in FIGS. 11 to 13, the housing 30 of the air flow rate measurement device 22 of the second embodiment does not have the physical quantity measurement passage inlet 500, the primary physical quantity measurement passage outlets 501, the secondary physical quantity measurement passage outlets 502 and the physical quantity measurement passage 50. Since the physical quantity measurement passage inlet 500 is not formed, the third housing inner surface 63 and the fourth housing inner surface 64 are not formed in the second embodiment.

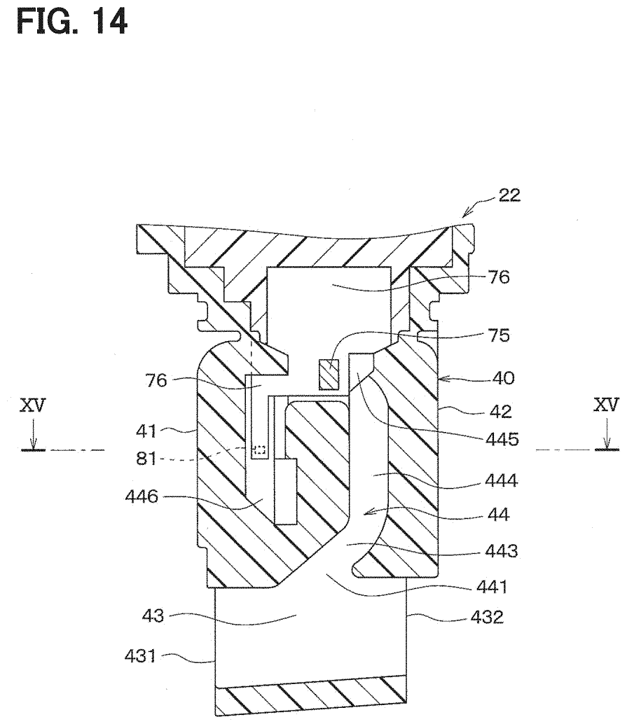

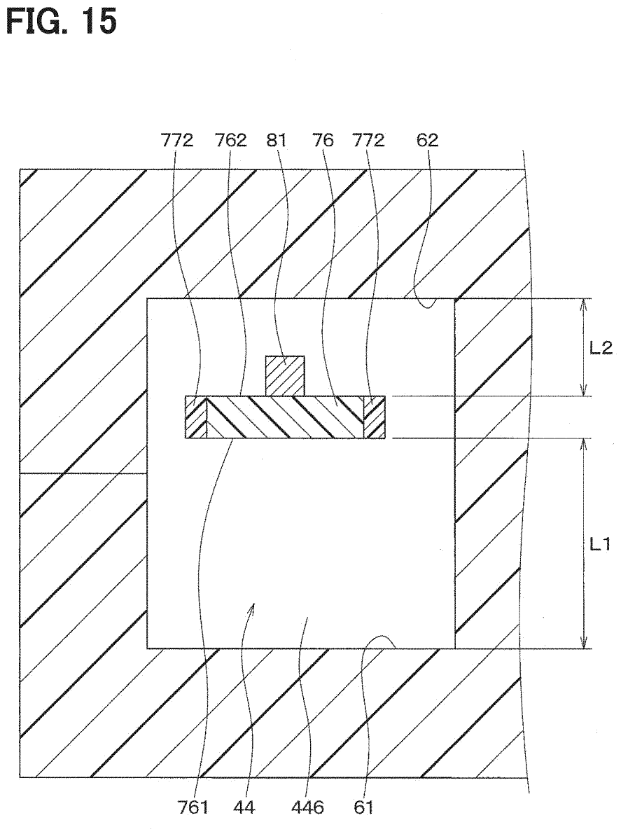

Furthermore, as shown in FIG. 14, the circuit board 76 extends from the location of the return portion 445 of the flow rate measurement sub-passage 44 to a center part of the front vertical portion 446 of the flow rate measurement sub-passage 44. As shown in FIG. 15, the physical quantity sensing device 81 is installed to a corresponding section of the secondary circuit board end part 762 of the circuit board 76 located in the front vertical portion 446 of the flow rate measurement sub-passage 44. Therefore, the physical quantity sensing device 81 is located on the downstream side of the flow rate sensing device 75 in the flow direction of the air flowing in the flow rate measurement sub-passage 44 and is opposed to the second housing inner surface 62. The physical quantity sensing device 81 outputs a signal that corresponds to the temperature of the air flowing in the front vertical portion 446 of the flow rate measurement sub-passage 44.

The secondary circuit board protectors 772 respectively cover a surface of the circuit board 76 placed on the housing base surface 41 side and a surface of the circuit board 76 placed on the housing back surface 42 side to protect the circuit board 76 while the circuit board 76 is located in the front vertical portion 446 of the flow rate measurement sub-passage 44. Furthermore, in the cross section, which is perpendicular to the width direction and the plate thickness direction of the circuit board 76, the outer periphery of each of the secondary circuit board protectors 772 has a shape that extends along the flow of the air in the flow rate measurement sub-passage 44. For example, in the cross section, which is perpendicular to the longitudinal direction of the circuit board 76, the outer periphery of the secondary circuit board protector 772 is shaped in a form of an elongated rectangle.

The air flow rate measurement device 22 is constructed in the above-described manner. Next, the measurement of the flow rate and the temperature by the air flow rate measurement device 22 will be described.

A portion of the air, which flows in the air intake passage 111, flows into the flow rate measurement main passage inlet 431. The air, which flows from the flow rate measurement main passage inlet 431, flows in the flow rate measurement main passage 43 toward the flow rate measurement main passage outlet 432. A portion of the air, which flows in the flow rate measurement main passage 43, is discharged to the outside of the housing 30 through the flow rate measurement main passage outlet 432.

Furthermore, another portion of the air, which flows in the flow rate measurement main passage 43, flows into the flow rate measurement sub-passage inlet 441. The air, which flows from the flow rate measurement sub-passage inlet 441, flows in the return portion 445 after passing through the introducing portion 443 and the rear vertical portion 444 of the flow rate measurement sub-passage 44. A portion of the air, which flows in the return portion 445, contacts the flow rate sensing device 75. Due to the contact of the flow rate sensing device 75 with the air, the flow rate sensing device 75 outputs a signal that corresponds to the flow rate of the air, which flows in the flow rate measurement sub-passage 44. The output signal of the flow rate sensing device 75 is transmitted to the electronic control device 18 through the corresponding terminal 35.

Furthermore, the air, which flows in the return portion 445, flows into the front vertical portion 446 of the flow rate measurement sub-passage 44. A portion of the air, which flows in the front vertical portion 446 of the flow rate measurement sub-passage 44, contacts the physical quantity sensing device 81. Due to the contact of the physical quantity sensing device 81 with the air, the physical quantity sensing device 81 outputs the signal that corresponds to the temperature of the air flowing in the front vertical portion 446 of the flow rate measurement sub-passage 44. The output signal of the physical quantity sensing device 81 is transmitted to the electronic control device 18 through the circuit board 76 and the corresponding terminal 35. Furthermore, the air, which flows in the front vertical portion 446 of the flow rate measurement sub-passage 44, is discharged to the outside of the housing 30 through the flow rate measurement sub-passage outlets 442.

As discussed above, the air flow rate measurement device 22 measures the flow rate of the air and the temperature of the air.

Even in the second embodiment, advantages, which are similar to those of the first embodiment, can be achieved. Furthermore, in the second embodiment, the physical quantity sensing device 81 is not located in the physical quantity measurement passage 50, which is different from the flow rate measurement main passage 43 and the flow rate measurement sub-passage 44, but the physical quantity sensing device 81 is located on the downstream side of the flow rate sensing device 75 in the flow direction of the air flowing in the flow rate measurement sub-passage 44. Furthermore, the physical quantity sensing device 81 is installed to the secondary circuit board end part 762 of the circuit board 76 and is located at the side of the circuit board 76 which is opposite to the flow rate sensing device 75. Therefore, the physical quantity sensing device 81 does not have an influence such as disturbing the air flowing in the return portion 445 of the flow rate measurement sub-passage 44. Thus, the air flow rate measurement device 22 of the second embodiment can achieve the advantage which is similar to the advantage recited at the section (3) discussed above.

Furthermore, the second distance L2 is larger than zero, and the physical quantity sensing device 81 is less likely to come into contact with the second housing inner surface 62. Thus, the air flow rate measurement device 22 of the second embodiment can achieve the advantage which is similar to the advantage recited at the section (4) discussed above.

Furthermore, each of the secondary circuit board protectors 772 covers the corresponding surface of the circuit board 76 which extends in the plate thickness direction of the circuit board 76 and is located in the front vertical portion 446 of the flow rate measurement sub-passage 44. In this way, the corrosion of the circuit board 76 is limited. Thus, the air flow rate measurement device 22 of the second embodiment can achieve the advantage which is similar to the advantage recited at the section (5) discussed above.

### Other Embodiments

The present disclosure is not necessarily limited to the above embodiments, and the above embodiments may be suitably modified. Further, in each of the above embodiments, it is needless to say that the elements constituting the embodiment are not necessarily essential unless explicitly specified as being essential or in principle considered to be essential.

(1) In the above embodiment, the physical quantity sensing device 81 outputs the signal which corresponds to the temperature of the air flowing in the physical quantity measurement passage 50. However, the physical quantity sensing device 81 should not be limited to the above configuration where the physical quantity sensing device 81 outputs the signal, which corresponds to the temperature of the airflowing in the physical quantity measurement passage 50, and the physical quantity sensing device 81 may be configured to output a signal, which corresponds to a relative humidity of the air flowing in the physical quantity measurement passage 50. Furthermore, the physical quantity sensing device 81 may output a signal, which corresponds to a pressure of the airflowing in the physical quantity measurement passage 50. Like the measurement accuracy of the temperature, the measurement accuracy of the relative humidity and the measurement accuracy of the pressure will be deteriorated by the influence of the heat from the housing 30. Therefore, in the above embodiments, the physical quantity sensing device 81 is less likely to be influenced by the heat transfer from the housing 30, so that the air flow rate measurement device 21, 22 can improve the measurement accuracy of the relative humidity of the air and the measurement accuracy of the pressure of the air.

(2) In the above embodiments, the first housing inner surface 61 and the second housing inner surface 62 are respectively shaped as a planar surface. However, the first housing inner surface 61 and the second housing inner surface 62 are not necessarily respectively shaped as the planar surface. For example, the first housing inner surface 61 and the second housing inner surface 62 may be respectively shaped as a curved surface or a stepped surface. In such a case, in the cross section, which is perpendicular to the longitudinal direction of the circuit board 76, a minimum distance, which is measured from the first housing inner surface 61 to the primary circuit board end part 761 in the plate thickness direction of the circuit board 76, serves as the first distance L1. Furthermore, in the cross section, which is perpendicular to the longitudinal direction of the circuit board 76, a minimum distance, which is measured from the second housing inner surface 62 to the secondary circuit board end part 762 in the plate thickness direction of the circuit board 76, serves as the second distance L2.

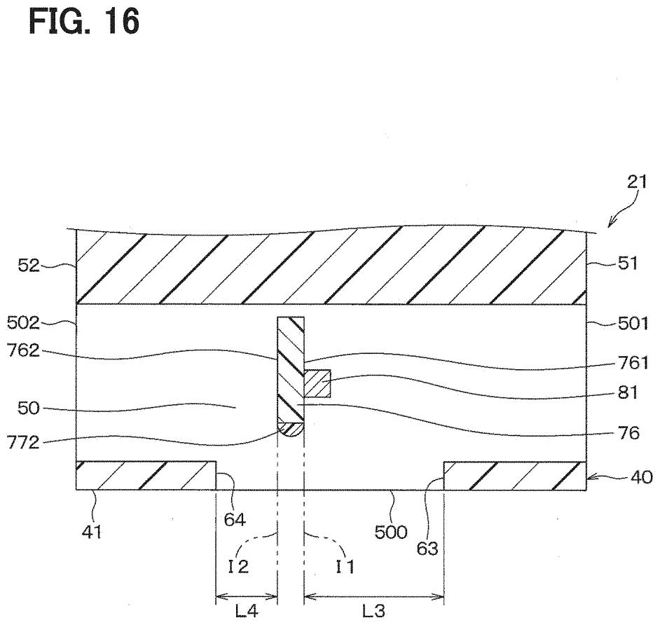

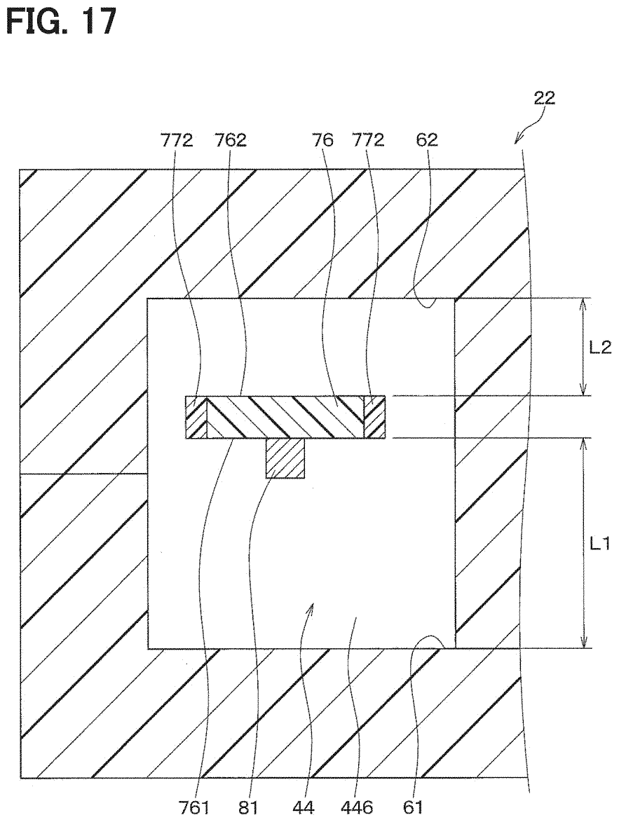

(3) In the first embodiment and the second embodiment, the physical quantity sensing device 81 is installed to the secondary circuit board end part 762 of the circuit board 76. However, the physical quantity sensing device 81 is not limited to being installed to the secondary circuit board end part 762 of the circuit board 76. For example, in the first embodiment, as shown in FIG. 16, the physical quantity sensing device 81 may be installed to the primary circuit board end part 761 of the circuit board 76. Furthermore, in the second embodiment, as shown in FIG. 17, the physical quantity sensing device 81 may be installed to the primary circuit board end part 761 of the circuit board 76. Even in these cases, the advantages, which are similar to those of the above-described ones, can be achieved.

(4) In the first embodiment, the plurality of primary physical quantity measurement passage outlets 501 are formed at the primary housing lateral surface 51, and the plurality of secondary physical quantity measurement passage outlets 502 are formed at the secondary housing lateral surface 52. Alternatively, while the plurality of primary physical quantity measurement passage outlets 501 are formed at the primary housing lateral surface 51, the secondary physical quantity measurement passage outlets 502 may be eliminated from the secondary housing lateral surface 52. Further alternatively, while the plurality of secondary physical quantity measurement passage outlets 502 are formed at the secondary housing lateral surface 52, the primary physical quantity measurement passage outlets 501 may be eliminated from the primary housing lateral surface 51.

(5) In the first embodiment, the number of the primary physical quantity measurement passage outlets 501 is three, and the number of the secondary physical quantity measurement passage outlets 502 is three. However, the number of the primary physical quantity measurement passage outlets 501 and the number of the secondary physical quantity measurement passage outlets 502 should not be respectively limited to three and may be changed to one, two or four or more. Furthermore, in the above embodiments, the primary physical quantity measurement passage outlets 501 and the secondary physical quantity measurement passage outlets 502 are respectively shaped in an elongated rectangular shape. However, the shape of the respective primary physical quantity measurement passage outlets 501 and the shape of the respective secondary physical quantity measurement passage outlets 502 are not necessarily limited to the elongated rectangular shape and may be a polygonal shape, a circular shape or an elliptical shape.

(6) In the first embodiment, the number of the physical quantity measurement passage inlet 500 is one. However, the number of the physical quantity measurement passage inlet(s) 500 is not necessarily limited to one and may be changed to two or more. Furthermore, in the above embodiments, the physical quantity measurement passage inlet 500 is shaped in an elongate rectangular shape. However, the shape of the physical quantity measurement passage inlet 500 is not necessarily limited to the elongated rectangular shape and may be a polygonal shape, a circular shape or an elliptical shape.

(7) In the first embodiment, in the cross section, which is perpendicular to the longitudinal direction of the circuit board 76, the outer periphery of each of the primary circuit board protectors 771 has the semi-circular shape. However, in the cross section, which is perpendicular to the longitudinal direction of the circuit board 76, the outer periphery of the primary circuit board protector 771 does not necessarily have the semi-circular shape.

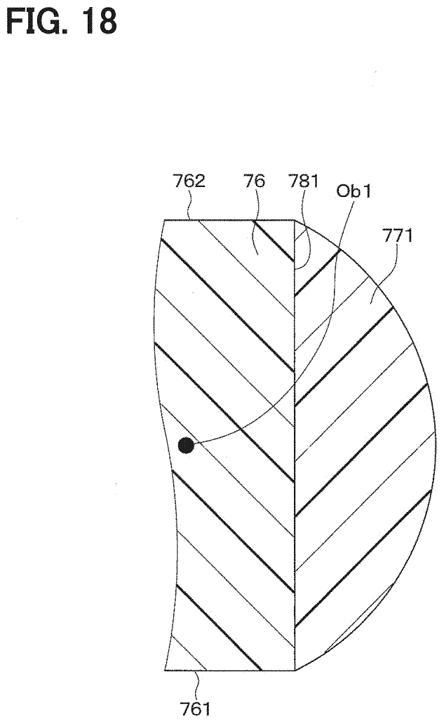

For example, as shown in FIG. 18, in the cross section, which is perpendicular to the longitudinal direction of the circuit board 76, the outer periphery of the primary circuit board protector 771 may have an arcuate shape that has a central angle smaller than 180 degrees. In such a case, the primary center of curvature Ob1 of the outer periphery of the primary circuit board protector 771 is located at the inside of the circuit board 76.

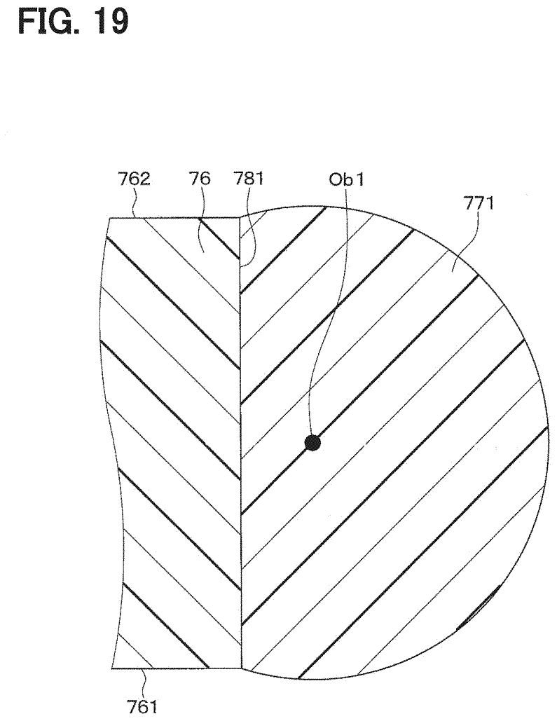

Furthermore, as shown in FIG. 19, in the cross section, which is perpendicular to the longitudinal direction of the circuit board 76, the outer periphery of the primary circuit board protector 771 may have an arcuate shape that has a central angle larger than 180 degrees. In such a case, the primary center of curvature Ob1 of the outer periphery of the primary circuit board protector 771 is located at the outside of the circuit board 76 and the inside of the primary circuit board protector 771.

Furthermore, the outer periphery of the primary circuit board protector 771 may have a shape that is formed by combining an arc having the primary center of curvature Ob1b located at the inside of the circuit board 76 and an arc having the primary center of curvature Ob1 located at the inside of the primary circuit board protector 771.

(8) In the first embodiment, in the cross section, which is perpendicular to the longitudinal direction of the circuit board 76, the outer periphery of the secondary circuit board protector 772 has the semi-circular shape. However, in the cross section, which is perpendicular to the longitudinal direction of the circuit board 76, the outer periphery of the secondary circuit board protector 772 does not necessarily have the semi-circular shape. Like the primary circuit board protector 771 described above, in the cross section, which is perpendicular to the longitudinal direction of the circuit board 76, the outer periphery of the secondary circuit board protector 772 may have an arcuate shape that has a central angle smaller than 180 degrees. In such a case, the secondary center of curvature Ob2 of the outer periphery of the secondary circuit board protector 772 is located at the inside of the circuit board 76. Furthermore, like the primary circuit board protector 771 described above, in the cross section, which is perpendicular to the longitudinal direction of the circuit board 76, the outer periphery of the secondary circuit board protector 772 may have an arcuate shape that has a central angle larger than 280 degrees. In such a case, the secondary center of curvature Ob2 of the outer periphery of the secondary circuit board protector 772 is located at the outside of the circuit board 76 but is at the inside of the secondary circuit board protector 772. Furthermore, the outer periphery of the secondary circuit board protector 772 may have a shape that is formed by combining an arc having the secondary center of curvature Ob2 located at the inside of the circuit board 76 and an arc having the secondary center of curvature Ob2 located at the inside of the secondary circuit board protector 772.

(9) In the first embodiment, the third housing inner surface 63 and the fourth housing inner surface 64 are respectively shaped as a planar surface. However, the third housing inner surface 63 and the fourth housing inner surface 64 are not necessarily respectively shaped as the planar surface. For example, the third housing inner surface 63 and the fourth housing inner surface 64 may be respectively shaped as a curved surface or a stepped surface. In such a case, in the cross section, which is perpendicular to the longitudinal direction of the circuit board 76, a minimum distance, which is measured from the third housing inner surface 63 to the primary circuit board end part 761 in the plate thickness direction of the circuit board 76, serves as the third distance L3. Furthermore, in the cross section, which is perpendicular to the longitudinal direction of the circuit board 76, a minimum distance, which is measured from the fourth housing inner surface 64 to the secondary circuit board end part 762 in the plate thickness direction of the circuit board 76, serves as the fourth distance L4.

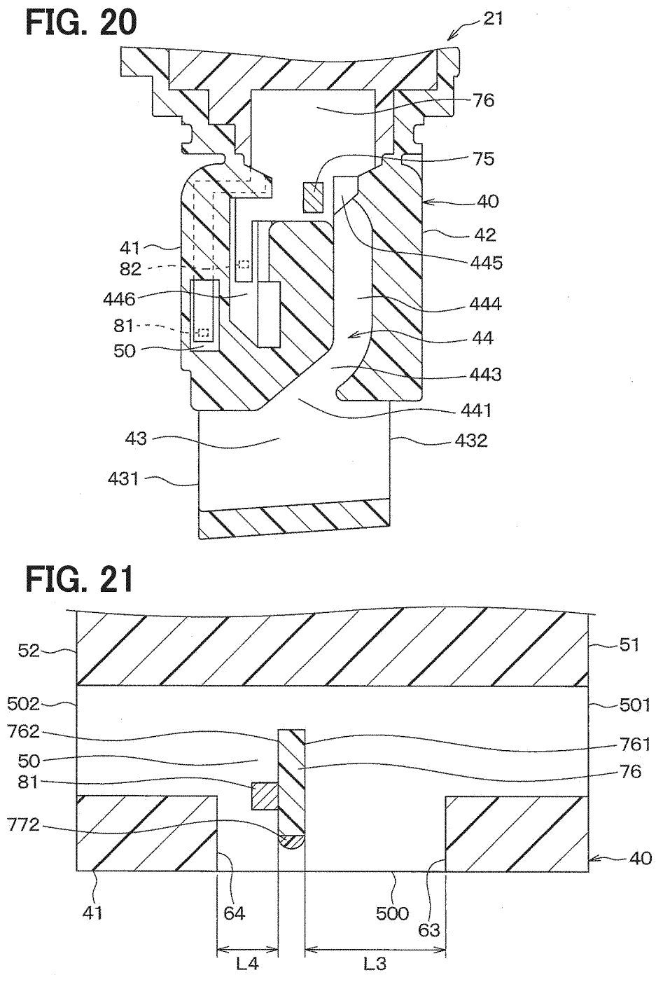

(10) The air flow rate measurement device 21 of the first embodiment and the air flow rate measurement device 22 of the second embodiment may be combined together. Specifically, as shown in FIG. 20, like the first embodiment, the circuit board 76 extends from the location of the return portion 445 of the flow rate measurement sub-passage 44 to the physical quantity measurement passage 50, and the physical quantity sensing device 81 is installed to a corresponding section of the circuit board 76 located in the physical quantity measurement passage 50. Furthermore, in the air flow rate measurement device 21 of the first embodiment, the circuit board 76 extends from the location of the return portion 445 of the flow rate measurement sub-passage 44 to the center part of the front vertical portion 446 of the flow rate measurement sub-passage 44. Furthermore, the air flow rate measurement device 21 of the first embodiment further includes a physical quantity sensing device 82 that is different from the physical quantity sensing device 81. The physical quantity sensing device 82 is installed to a corresponding section of the secondary circuit board end part 762 of the circuit board 76 located in the front vertical portion 446 of the flow rate measurement sub-passage 44. Therefore, the physical quantity sensing device 82 is located on the downstream side of the flow rate sensing device 75 in the flow direction of the air flowing in the flow rate measurement sub-passage 44 and is opposed to the second housing inner surface 62. Furthermore, the physical quantity sensing device 82 outputs a signal that corresponds to a physical quantity of the air flowing in the front vertical portion 446 of the flow rate measurement sub-passage 44. In this instance, the physical quantity of the air, which flows in the front vertical portion 446 of the flow rate measurement sub-passage 44, is different from the physical quantity that is sensed by the physical quantity sensing device 81. For example, the physical quantity sensing device 82 outputs a signal that corresponds to a relative humidity of the air flowing in the front vertical portion 446 of the flow rate measurement sub-passage 44. Alternatively, the physical quantity sensing device 82 outputs a signal that corresponds to a pressure of the air flowing in the front vertical portion 446 of the flow rate measurement sub-passage 44. Even in these cases, the advantages, which are similar to those of the above-described ones, can be achieved.

(11) In the first embodiment, the section of the circuit board 76, which is located in the physical quantity measurement passage 50, is opposed to the primary physical quantity measurement passage outlets 501 and the secondary physical quantity measurement passage outlets 502. However, the circuit board 76 is not necessarily opposed to the primary physical quantity measurement passage outlets 501 and the secondary physical quantity measurement passage outlets 502. For example, as shown in FIG. 21, the circuit board 76 may be opposed to the primary physical quantity measurement passage outlets 501, the secondary physical quantity measurement passage outlets 502, the third housing inner surface 63 and the fourth housing inner surface 64. In such a case, in the cross section, which is perpendicular to the longitudinal direction of the circuit board 76, a distance, which is measured from the third housing inner surface 63 to the primary circuit board end part 761 in the plate thickness direction of the circuit board 76, serves as the third distance L3. Furthermore, in the cross section, which is perpendicular to the longitudinal direction of the circuit board 76, a distance, which is measured from the fourth housing inner surface 64 to the secondary circuit board end part 762 in the plate thickness direction of the circuit board 76, serves as the fourth distance L4.

Furthermore, in the first embodiment, the physical quantity sensing device 81 is opposed to the secondary physical quantity measurement passage outlets 502. However, the physical quantity sensing device 81 is not necessarily opposed to the secondary physical quantity measurement passage outlets 502. The physical quantity sensing device 81 may be opposed to the secondary physical quantity measurement passage outlets 502 and the fourth housing inner surface 64.

(12) In the above embodiments, the pipe extension 112 is shaped in the cylindrical tubular form. However, the pipe extension 112 is not necessarily shaped in the cylindrical tubular form. For example, the pipe extension 112 may be shaped in another tubular form, such as a polygonal tubular form.

(13) In the above embodiments, the holding portion 31 is shaped in the cylindrical tubular form. However, the holding portion 31 is not necessarily shaped in the cylindrical tubular form. For example, the holding portion 31 may be shaped in another tubular form, such as a polygonal tubular form.

(14) In the above embodiments, the connector cover 34 extends from the radially inner side toward the radially outer side of the holding portion 31. However, the connector cover 34 does not necessarily extend from the radially inner side toward the radially outer side of the holding portion 31. For example, the connector cover 34 may extend in the axial direction of the holding portion 31.

(15) In the above embodiments, the flow rate measurement sub-passage 44 is the passage that is branched from the middle of the flow rate measurement main passage 43. However, the flow rate measurement sub-passage 44 is not necessarily limited to the passage that is branched from the middle of the flow rate measurement main passage 43. For example, instead of communicating the flow rate measurement main passage 43 with the flow rate measurement main passage outlet 432, the flow rate measurement sub-passage 44 may be communicated with the flow rate measurement main passage outlet 432 such that the flow rate measurement main passage 43 and the flow rate measurement sub-passage 44 form one flow passage.

What is claimed is:

1. An air flow rate measurement device comprising:
a housing that has:
a base surface;
a back surface that is opposed to the base surface;
a primary lateral surface that is connected to one end part of the base surface and one end part of the back surface;
a secondary lateral surface that is connected to another end part of the base surface, which is opposite to the primary lateral surface, and another end part of the back surface, which is opposite to the primary lateral surface;
a flow rate measurement passage inlet that is formed at the base surface;
a flow rate measurement passage outlet that is formed at the back surface; and
a flow rate measurement passage that is communicated with the flow rate measurement passage inlet and the flow rate measurement passage outlet;
a circuit board that is located in the flow rate measurement passage; and
a flow rate sensing device that is configured to output a signal which corresponds to a flow rate of air flowing in the flow rate measurement passage, wherein:
the flow rate measurement passage has:
a first inner surface that is located at one side of the flow rate measurement passage where the primary lateral surface is placed; and
a second inner surface that is located at another side of the flow rate measurement passage where the secondary lateral surface is placed;
the flow rate sensing device is installed to one side of the circuit board where the first inner surface is placed;
a distance, which is measured from the circuit board to the first inner surface in a plate thickness direction of the circuit board, is larger than a distance, which is measured from the circuit board to the second inner surface in the plate thickness direction of the circuit board; and
the distance, which is measured from the circuit board to the second inner surface in the plate thickness direction of the circuit board, is larger than zero.

2. The air flow rate measurement device according to claim 1, comprising a physical quantity sensing device that is installed to the circuit board and is configured to output a signal which corresponds to a physical quantity of the air flowing in the flow rate measurement passage.

3. The air flow rate measurement device according to claim 1, wherein:
the housing has:
a physical quantity measurement passage inlet that is formed at the base surface;
a physical quantity measurement passage outlet that is formed at one of the primary lateral surface and the secondary lateral surface; and
a physical quantity measurement passage that is communicated with the physical quantity measurement passage inlet and the physical quantity measurement passage outlet;
the circuit board is located in the flow rate measurement passage and the physical quantity measurement passage; and
the air flow rate measurement device comprises a physical quantity sensing device that is installed to the circuit board and is configured to output a signal which corresponds to a physical quantity of the air flowing in the physical quantity measurement passage.

4. The air flow rate measurement device according to claim 3, wherein:
the physical quantity measurement passage inlet has a third inner surface that is located at a side of the physical quantity measurement passage inlet where the secondary lateral surface is placed, and the third inner surface is connected to the base surface; and
a distance, which is measured from the circuit board to the third inner surface in the plate thickness direction of the circuit board, is larger than zero.

5. The air flow rate measurement device according to claim 2, wherein the physical quantity sensing device is installed to another side of the circuit board where the second inner surface is placed.

6. The air flow rate measurement device according to claim 1, further comprising a circuit board protector that covers the circuit board, wherein the circuit board protector has an outer periphery that is convexly curved.
